(19) United States
(12) Patent Application Publication
(10) Pub. No.: US 2023/0003253 A1
(43) Pub. Date: Jan. 5, 2023

(54) HYDROSTATIC BEARING FOR PRECISION LINEAR MOTION GUIDANCE

(71) Applicant: Moore Nanotechnology Systems, LLC, Swanzey, NH (US)

(72) Inventors: Thomas Dupell, Walpole, NH (US); Christopher Morgan, Keene, NH (US); Sinan J. Badrawy, Peterborough, NH (US); Mitchell Schadler, Keene, NH (US); Jeffrey Alan Lowe, North Springfield, VT (US)

(73) Assignee: Moore Nanotechnology Systems, LLC, Swanzey, NH (US)

(21) Appl. No.: 17/853,030

(22) Filed: Jun. 29, 2022

Related U.S. Application Data
(60) Provisional application No. 63/217,103, filed on Jun. 30, 2021.

(51) Int. Cl. F16C 29/02

(52) U.S. Cl. CPC F16C 29/025

(57) ABSTRACT

According to one example, a hydrostatic bearing includes a carriage, and a guide rail that, when combined with the carriage, provides for linear motion of the carriage with respect to the guide rail. The hydrostatic bearing is configured to transfer forces between the carriage and the guide rail without mechanical contact between the carriage and the guide rail by supplying pressurized, incompressible fluid to bearing pockets in the carriage. Each of the bearing pockets is enclosed by a bearing land of a bearing pad, and the bearing pad comprises the general shape of a parallelogram, a trapezoid, an arrow, or any other shape where the edges are generally not orthogonal to the direction of motion.

### CROSS-REFERENCE TO RELATED APPLICATIONS

This application claims priority to U.S. Provisional Patent Application No. 63/217,103 entitled “Hydrostatic Bearing for Precision Linear Motion Guidance” and filed Jun. 30, 2021, the entirety of which is incorporated herein by reference.

### TECHNICAL FIELD

This disclosure relates generally to hydrostatic bearings, and more particularly to a hydrostatic bearing for precision linear motion guidance.

### BACKGROUND

Hydrostatic bearings are utilized to achieve precision linear motion in machines, such as machine tools. Typical examples of hydrostatic bearings are described in U.S. Pat. Nos. 5,466,071, 5,871,285, Precision Machine Design by Slocum (Prentice Hall, 1992), and European Patent No. 0 304 090, each of which is incorporated herein by reference in its entirety. These typical hydrostatic bearings, however, may be deficient.

### SUMMARY

According to one example, a hydrostatic bearing includes a carriage, and a guide rail that, when combined with the carriage, provides for linear motion of the carriage with respect to the guide rail. The hydrostatic bearing is configured to transfer forces between the carriage and the guide rail without mechanical contact between the carriage and the guide rail by supplying pressurized, incompressible fluid to bearing pockets in the carriage. Each of the bearing pockets is enclosed by a bearing land of a bearing pad, and the bearing pad comprises the general shape of a parallelogram, a trapezoid, an arrow, or any other shape where the edges are generally not orthogonal to the direction of motion (e.g., the direction of motion is linear and defined by a line, and the edge of the bearing pad does not lie on the plane orthogonal to the line). The shape of the bearing pad minimizes carriage error motion due to periodic patterns in a bearing rail surface, in some examples. The shape also distributes the pressure intrinsically to minimize carriage error motion while maintaining stiffness, in some examples.

According to another example, a hydrostatic (pressurized fluid film) linear bearing comprises a pressurized pocket for supplying fluid across a bearing land such that high bearing stiffness and load capacity are achieved. The geometrical shape of the pressurized pocket and bearing land enable precision machine motion by distributing the pressure over a distance, in the direction of travel, such that the influence of periodic patterns in the bearing rail surface are reduced, in some examples.

According to a further example, a hydrostatic linear bearing includes a hydrostatic bearing pad that has a shape that reduces the error motion of the hydrostatic linear bearing resulting from periodic geometrical patterns in the bearing rail surface. This shape provides an improvement in the precision of the linear axis motion, in some examples.

### BRIEF DESCRIPTION OF THE DRAWINGS

For a more complete understanding of the present disclosure and its features and advantages, reference is now made to the following description, taken in conjunction with the accompanying drawings, in which:

FIGS. 1A-1C are isometric views of an example hydrostatic bearing with six pairs of opposed bearing pads.

FIG. 2A (top view) and FIG. 2B (side view) are a simplified representation of a linear hydrostatic bearing that includes a carriage and rail. The bearing pad of FIGS. 2A-2B is rectangular in shape, which is known in the prior art.

FIGS. 3A-3C illustrate examples of linear hydrostatic bearing pad shapes which may reduce the carriage error motion due to periodic rail straightness errors.

FIG. 4 illustrates another example linear hydrostatic bearing pad shape that may reduce the carriage error motion due to periodic rail straightness errors, where the bearing pad is in the shape of an arrow with a small segment oriented normal to the direction of travel.

FIG. 5A (top view) and FIG. 5B (side view) are a simplified representation of an example linear hydrostatic bearing that includes a carriage and rail, where the bearing pad is shaped as a parallelogram.

FIG. 6 is a plot of the resulting change in force during motion of a linear hydrostatic bearing, the force change resulting from periodic patterns in the bearing rail of wavelength l and amplitude a.

### DETAILED DESCRIPTION

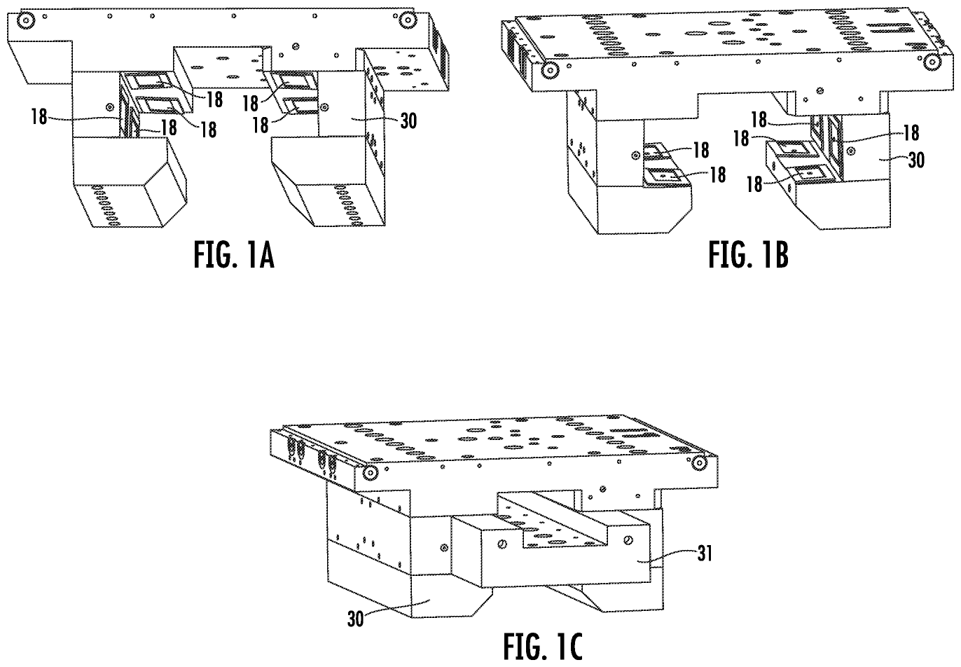

Examples of the present disclosure are best understood by referring to FIGS. 1A-6 of the drawings, like numerals being used for like and corresponding parts of the various drawings.

Hydrostatic bearings are utilized to achieve precision linear motion in machines, such as machine tools. Linear hydrostatic bearings include a carriage and a guide rail upon which the carriage moves or slides. Typically, the rail is longer than the carriage, and has straight surfaces for the carriage to move along, creating single degree-of-freedom linear motion. The carriage contains bearing pads which each include a bearing pocket and a bearing land. The bearing pocket contains pressurized fluid which flows across the bearing land to separate the carriage and the rail by a thin film of the pressurized fluid preventing mechanical contact. The bearing lands have a width over which the pressure of the film drops from the pressure in the bearing pocket to atmospheric pressure. The film provides stiffness and reduced-friction motion between the carriage and rail. The fluid may be oil, water, or any other incompressible fluid that will separate the carriage and rail when placed under pressure in the bearing pocket.

As the carriage moves along the rail, the carriage follows the geometry of the rail surface. For example, if a rail surface has the general shape of an arc, rather than a straight line, then the carriage will follow the arc. Precision motion applications require straight, linear motion, and motion deviating from a straight line is classified as error motion. While error motion is undesirable, manufacturing a perfectly straight rail surface is not practical. Typically, rail surfaces are manufactured by machines that contain intrinsic error motions which directly affect the geometry of the rail surface. The machine error motions are typically not random but rather periodic in nature. For example, the arc discussed above could be described by a rail surface exhibiting a sinusoidal pattern with a certain spatial wavelength. If the wavelength sinusoidal pattern is small, error motion of the carriage is small due to an averaging effect of the fluid film stiffness, for instance, if the wavelength is much smaller, or shorter, than the bearing land width. Therefore, precise motion can be achieved by maintaining a low amplitude of periodic patterns in a rail surface, with wavelengths of the patterns being much smaller than the bearing land widths, in some examples. Achieving low amplitude periodic patterns is not always practical for manufacturing processes like surface grinding. Also, the bearing land width could be increased to reduce the effect of the periodic pattern, but increasing the bearing land width reduces bearing stiffness and is, therefore, not desired.

FIGS. 1A-1C illustrate an example of a hydrostatic linear bearing having six pairs of opposed bearing pads 18, said bearing pads 18 having a rectangular shape. The bearing pads 18 are oriented parallel and opposed such that the force applied to the carriage 30 by the bearing pad 18 is equal and opposite creating zero force on the carriage 30 in the plane orthogonal to motion. The bearing pad 18 is of a rectangular shape with all pads 18 having an opposing pair, but other arrangements and numbers of the bearing pads 18 may be utilized to achieve zero force, such as dovetail rails and carriages. FIGS. 1A and 1B are isometric views of a carriage 30 of the hydrostatic bearing, and FIG. 1C is an isometric view of a carriage 30 combined with a guide rail 31 of the hydrostatic bearing.

The hydrostatic bearing includes the carriage 30 and the guide rail 31. The carriage 30 includes bearing pads 18 containing pressurized fluid. The fluid may be oil or water, or any incompressible fluid. The rail 31 may be any straight object that has a cross section about which the carriage 30 translates. The cross section may be a square, triangle, circle, or any shape such that the bearing pads 18 can be oriented so that the sum of forces created by the bearing pad 18 may sum to zero (an example of which is seen in European Patent No. 0 304 090).

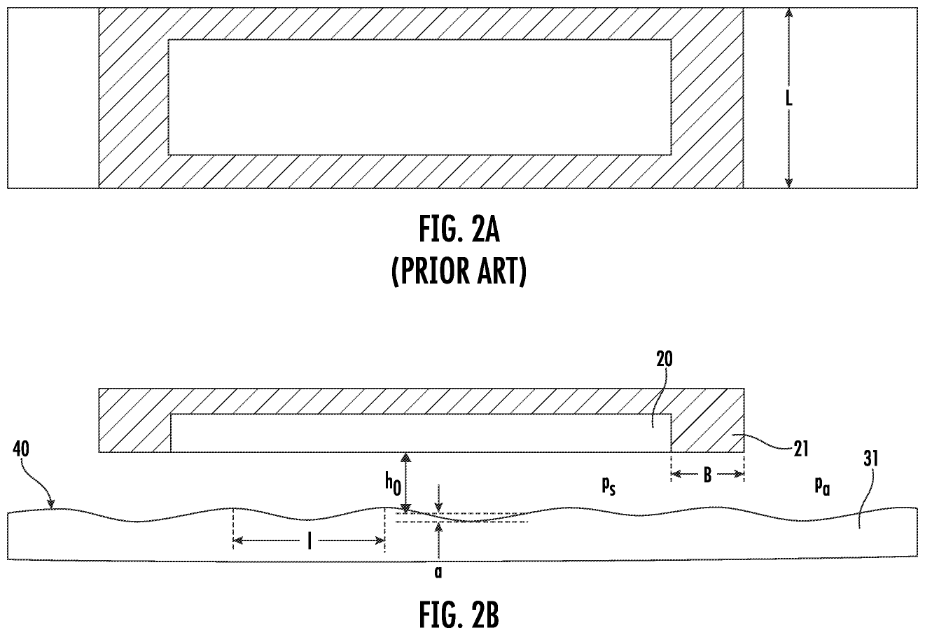

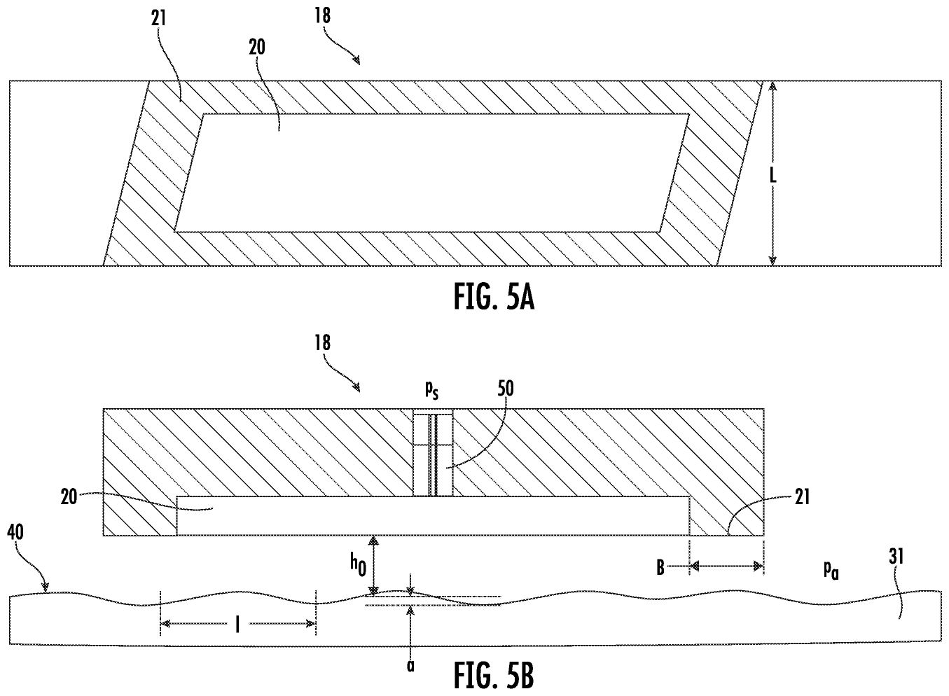

The pressurized fluid flows over a bearing land 21 to create high stiffness and squeeze film damping. The gap between the bearing land 21 and the rail 31 (shown in FIG. 2) is, typically, on the order of 8 to 25 micrometers, but may be as small or large as necessary to create high stiffness and squeeze film damping. The pressurized fluid in the bearing pocket 20 may be restricted from a capillary restrictor 50, orifice restrictor, or any type of restriction method. An example of a bearing pad 18 restricted by a capillary restrictor 50 is shown in FIGS. 5A-5B. The restrictor 50 is placed between the supply pressure and the bearing pocket 20. The bearing pocket 20 may be of any depth such that high stiffness and squeeze film damping is achieved across the bearing land 21.

For precision motion applications, such as the linear axis of a machine tool, the motion of the carriage 30 should be as straight as possible. The carriage 30 may have undesired motion, or error motion, if the rail surface is not geometrically straight in the direction of motion. The error motion may be a combination of two linear error motions, which are orthogonal to each other and orthogonal to the direction of travel, and three angular error motions termed roll, pitch, and yaw.

FIGS. 2A-2B are a simplified representation of a linear hydrostatic bearing that includes a carriage and rail. The bearing pad 18 of FIGS. 2A-2B is rectangular in shape, which is known in the prior art. The bearing rail surface has a periodic pattern of wavelength l and amplitude a. The nominal gap of the bearing being defined as h₀, the bearing land width defined as B, the bearing land length defined as L, the supply pressure defined as pₛ, the atmospheric pressure defined as pₐ.

If the geometry of a rail surface is assumed to be a summation of periodic patterns 40 (an example of which is shown in FIGS. 2A-2B), then the error motion of the carriage 30 will be a summation of the error motions resulting from each periodic pattern 40. The total error motion of the carriage 30, therefore, will vary with the amplitudes and wavelengths of the periodic patterns 40. The error motions occur when the carriage 30 traverses along the rail 31, passing over the periodic pattern 40 in the rail 31 which, as a result, causes the effective force created by the squeeze film to change. The change in force results in a change in position of the carriage 30, which is termed error motion.

The periodic pattern 40 of the rail 31 may derive from various sources. For instance, the rail 31 may be manufactured on a machine tool which itself has error motions. Those error motions will influence the rail 31 surface. Also, the tool shape utilized to manufacture the rail 31 may influence the rail 31 surface geometry. For example, a milling tool with a given number of cutting edges may create a pattern on the rail 31 surface as the milling tool machines the rail 31 surface. In another example, a grinding wheel on a surface grinding machine tool may not be round, therefore the oscillations of the wheel cause periodic structures on the rail 31 surface.

One approach to reducing the influence of the periodic patterns 40 on a rail 31 is to rotate, or skew, the rail 31 on the machine such that the straightness errors are not orthogonal to the rail 31 linear direction. But this approach is not always practical due to the space and size constraints of a machine tool. For instance, as the rail 31 is skewed, the required length of travel of a machine axis increases, which may exceed the machine tool length of travel. Also, the size of the mounting surface on the machine tool may not be adequate since the effective width of the rail 31 is increased as the rail 31 is skewed.

Another approach to minimizing the effect of periodic patterns 40 on the rail 31 surface is to position the periodic patterns 40 on opposing sides of rail 31 such that the changes in force are canceled. This technique is utilized for long wavelength errors, such as wavelengths longer than the rail 31 length. For example, the rail 31 surface may have an arc-like shape and the mirror image of the arc-like shape on the opposing rail surface. The force applied by each opposed pad 18 changes as the carriage 30 travels along the rail 31, but the forces are always equal and opposite and therefore no error motion occurs, in some examples. This strategy is possible for long wavelengths, but for shorter wavelengths (e.g., shorter than the bearing land 21 width), this strategy is challenging. The alignment, or phase, of the periodic error is difficult to align on the machine tool.

The hydrostatic bearing of the present disclosure may address one or more of these deficiencies. According to one example, the hydrostatic bearing includes a carriage 30, and a guide rail 31 that, when combined with the carriage 30, provides for linear motion of the carriage 30 with respect to the guide rail 31. The hydrostatic bearing is configured to transfer forces between the carriage 30 and the guide rail 31 without mechanical contact between the carriage 30 and the guide rail 31 by supplying pressurized, incompressible fluid to bearing pockets 20 in the carriage 30. Each of the bearing pockets 20 is enclosed by a bearing land 21 of a bearing pad 18, and the bearing pad 18 comprises the general shape of a parallelogram, a trapezoid, an arrow, or any other shape where the edges are generally not orthogonal to the direction of motion. The shape of the bearing pad 18 minimizes carriage error motion due to periodic patterns 40 in a bearing rail surface, in some examples. The shape also distributes the pressure intrinsically to minimize carriage error motion while maintaining stiffness, in some examples. Furthermore, the bearing pad 18 is for linear bearings, as opposed to rotary bearings.

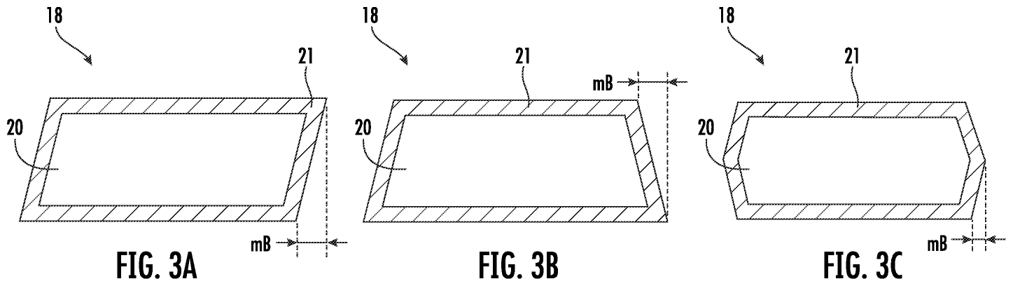

FIGS. 3A-3C illustrate examples of linear hydrostatic bearing pad 18 shapes which may reduce the carriage error motion due to periodic rail straightness errors. In FIG. 3A, the bearing pad 18 is in the shape of a parallelogram with no right angles. In FIG. 3B, the bearing pad 18 is in the shape of a trapezoid. In FIG. 3C, the bearing pad 18 is in the shape of an arrow.

As is mentioned above, in some examples, the shape of the bearing pad 18 (where the bearing pad 18 includes a bearing land 21 and a bearing pocket 20) is such that the edges are generally not orthogonal to the direction of motion. For example, the rectangle can have a skew in the direction of travel to create a parallelogram shaped bearing pad 18 (see FIG. 3A). The skew of the bearing pad 18 is defined as the skew ratio, m, multiplied by the bearing land width, B. In some examples, the skew ratio, m, must be greater than zero to achieve shapes with edges that are not orthogonal to the direction of motion. A typical value of skew ratio is 1.0, but the value could be higher, such as 10.0. As is illustrated in FIG. 3A, the bearing pad 18 has lines parallel to the direction of motion, but no lines orthogonal to the direction of motion. Furthermore, the bearing land 21 and the bearing pocket 20 may follow the shape of the bearing pad 18, and therefore, the bearing land 21 and/or the bearing pocket 20 may also have no edges that are orthogonal to the direction of motion.

In other examples, the bearing pad 18 can have a trapezoidal shape, which has no lines orthogonal to the direction of motion as shown in FIG. 3B. In further examples, the skew mB can have multiple occurrences across the bearing land 21 length, such as the arrow shape in FIG. 3C which has 2 sections over the bearing land 21 length.

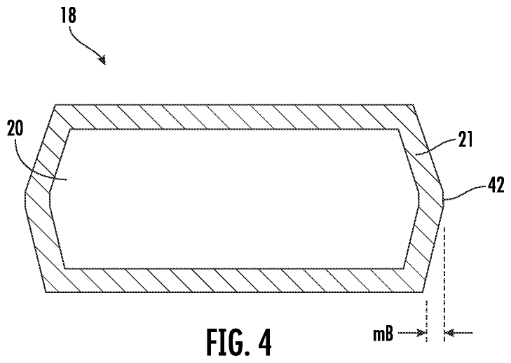

Other bearing pad 18 shapes may be possible while still achieving lines that are generally not orthogonal to the direction of motion. For example, FIG. 4 illustrates an example linear hydrostatic bearing pad 18 shape that may reduce the carriage error motion due to periodic rail straightness errors where the bearing pad 18 is in the shape of an arrow with a small segment 42 oriented normal to the direction of travel. The skew of the bearing is defined as the skew ratio, m, multiplied by the bearing land width, B. As is seen in FIG. 4, the bearing pad 18 is in the shape of an arrow with a small segment 42 of the bearing land 21 oriented normal (i.e., orthogonal) to the direction of travel such that the error motion of the carriage due to periodic patterns is still reduced. Therefore, a small amount of the bearing pad 18 can be orthogonal and still achieve the desired effect, in some examples.

FIGS. 5A-5B are a simplified representation of an example linear hydrostatic bearing that includes a carriage and rail. The bearing pad 18 is parallelogram in shape. The bearing rail surface has a periodic pattern of wavelength l and amplitude a. The nominal gap of the bearing being defined as h₀, the bearing land width defined as B, the bearing land length defined as L, the supply pressure defined as pₛ, the atmospheric pressure defined as pₐ. The pressure in the bearing pocket 20 has been compensated by a capillary restrictor 50 between the fluid supply and the bearing pocket 20. The capillary restrictor 50 creates a pressure drop that increases the stiffness of the bearing. This is generally known as a compensated hydrostatic bearing.

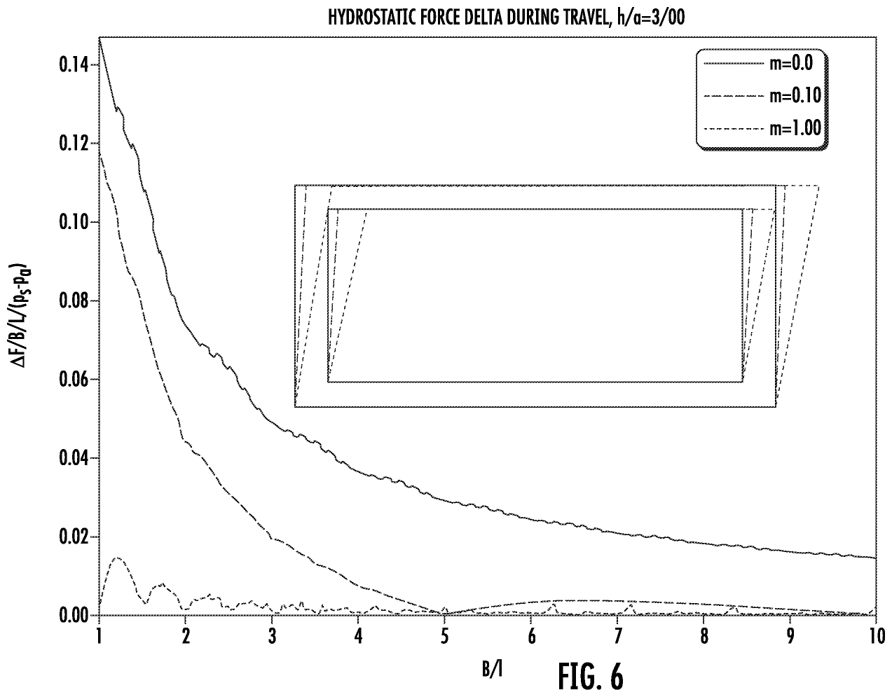

FIG. 6 is a plot of the resulting change in force during motion of a linear hydrostatic bearing, the force change resulting from periodic patterns in the bearing rail 31 of wavelength l and amplitude a. The nominal gap of the bearing being defined as h₀, the bearing land width defined as B, the bearing land length defined as L, the supply pressure defined as pₛ, the atmospheric pressure defined as pₐ. The variable m is defined as the skew ratio, which is equal to the skew distance of a parallelogram shaped bearing pad 18 divided by the bearing land width. The plot includes 3 lines defining various bearing pad 18 shapes. The first line, which is solid, defines m=0, which is a rectangular pad (prior art). In the second line, which is a long-dash, for m=0.1, the amount of skew is 10% of the bearing land width. In the third and final line, which is a short-dash, for m=1, the amount of skew is 100% of the bearing land width. Example shapes of the bearing pad also shown on the graph with corresponding line type. The plot shows that as m increases, the change in force is reduced. The bearing can be assumed to have linear stiffness, therefore a reduction in the change in force results in a reduction of the error motion of the carriage.

This specification has been written with reference to various non-limiting and non-exhaustive examples. However, it will be recognized by persons having ordinary skill in the art that various substitutions, modifications, or combinations of any of the disclosed examples (or portions thereof) may be made within the scope of this specification. Thus, it is contemplated and understood that this specification supports additional examples not expressly set forth in this specification. Such examples may be obtained, for example, by combining, modifying, or reorganizing any of the disclosed steps, components, elements, features, aspects, characteristics, limitations, and the like, of the various non-limiting and non-exhaustive examples described in this specification.

1. A hydrostatic bearing comprising:
a carriage; and
a guide rail that, when combined with the carriage, provides for linear motion of the carriage with respect to the guide rail, wherein the hydrostatic bearing is configured to transfer forces between the carriage and the rail without mechanical contact between the carriage and the guide rail by supplying pressurized, incompressible fluid to bearing pockets in the carriage, each of the bearing pockets being enclosed by a bearing land of a bearing pad, wherein the bearing pad comprises the general shape of a parallelogram with no right angles.

2. The hydrostatic bearing of claim 1, wherein the carriage comprises opposed bearing pads such that the force created by the opposing pads is equal.

3. The hydrostatic bearing of claim 2, further comprising a bearing gap sufficiently small to create high stiffness and squeeze film damping.

4. The hydrostatic bearing of claim 3, wherein the bearing gap is 8 to 25 micrometers.

5. The hydrostatic bearing of claim 2, wherein pressure in one or more of the bearing pockets is compensated by a capillary restrictor.

6. A hydrostatic bearing comprising:
a carriage; and
a guide rail that, when combined with the carriage, provides for linear motion of the carriage with respect to the guide rail, wherein the hydrostatic bearing is configured to transfer forces between the carriage and the rail without mechanical contact between the carriage and the guide rail by supplying pressurized, incompressible fluid to bearing pockets in the carriage, each of the bearing pockets being enclosed by a bearing land of a bearing pad, wherein the bearing pad comprises the general shape of a trapezoid.

7. The hydrostatic bearing of claim 6, wherein the carriage comprises opposed bearing pads such that the force created by the opposing pads is equal.

8. The hydrostatic bearing of claim 7, further comprising a bearing gap sufficiently small to create high stiffness and squeeze film damping.

9. The hydrostatic bearing of claim 8, wherein the bearing gap is 8 to 25 micrometers.

10. The hydrostatic bearing of claim 7, wherein pressure in one or more of the bearing pockets is compensated by a capillary restrictor.

11. A hydrostatic bearing comprising:
a carriage; and
a guide rail that, when combined with the carriage, provides for linear motion of the carriage with respect to the guide rail, wherein the hydrostatic bearing is configured to transfer forces between the carriage and the rail without mechanical contact between the carriage and the guide rail by supplying pressurized, incompressible fluid to bearing pockets in the carriage, each of the bearing pockets being enclosed by a bearing land of a bearing pad, wherein the bearing pad comprises the general shape of an arrow.

12. The hydrostatic bearing of claim 11, wherein the carriage comprises opposed bearing pads such that the force created by the opposing pads is equal.

13. The hydrostatic bearing of claim 12, further comprising a bearing gap sufficiently small to create high stiffness and squeeze film damping.

14. The hydrostatic bearing of claim 13, wherein the bearing gap is 8 to 25 micrometers.

15. The hydrostatic bearing of claim 12, wherein pressure in one or more of the bearing pockets is compensated by a capillary restrictor.
